(19) United States
(12) Patent Application Publication
(10) Pub. No.: US 2009/0277974 A1
(43) Pub. Date: Nov. 12, 2009

(54) Lawn And Garden Sprinkler Housing

(76) Inventors: Samino Citrawireja, Santa Rosa, CA (US); David Liu, San Francisco, CA (US)

Correspondence Address: Vierra Magen Marcus & DeNiro LLP, 575 Market Street, Suite 2500, San Francisco, CA, 94105, US

(21) Appl. No.: 12/436,726

(22) Filed: May 6, 2009

Related U.S. Application Data
(60) Provisional application No. 61/050,997, filed on May 6, 2008.

(51) Int. Cl. B05B 15/10

(52) U.S. Cl. 239/203; 239/200

(57) ABSTRACT

A housing structure useful for protecting and stabilizing internal elements, such as a lawn and garden sprinkler. A housing has a hollow cylindrical interior with an open top and bottom. A resilient member is fixed inside the housing, and a central opening in the resilient member accommodates the body of the sprinkler. An adaptor may be used within the resilient member to accommodate different sprinkler sizes. A cover plate fits in the top opening of the housing and includes a central opening that allows the sprinkler head to extend through the opening. The resilient member resists any lateral forces imparted against the sprinkler head. A notch may be formed in the housing to accommodate a water pipe that is coupled to the sprinkler.

### CROSS-REFERENCE TO RELATED APPLICATION

This disclosure claims the benefit of U.S. Provisional Application No. 61/050,997 entitled Lawn and Garden Sprinkler Housing, filed on May 6, 2008, which is incorporated herein by reference.

### BACKGROUND

This disclosure relates to lawn and garden sprinklers, and more particularly, to a housing for accommodating, protecting and stabilizing a lawn and garden sprinkler installation, and for providing easy access to the installation for sprinkler repairs.

A typical landscape irrigation system divides the landscape into “zones,” and each zone includes some number of individual sprinklers. Each sprinkler has a body which is connected to a water supply pipe, usually PVC plastic, and all piping and sprinkler bodies are buried in the ground. The piping connects back to an electronic controller for each zone. A sprinkler head extends from the buried sprinkler body to a position at or above grade. Sometimes a riser is connected between the main piping and the sprinkler body in order to raise the level of the sprinkler head, and sometimes a pop-up type sprinkler head is used, which is automatically raised above grade by the presence of water pressure provided to the sprinkler body.

A common problem among users of lawn and garden sprinklers is damage to the sprinkler body and/or head as a result of some force acting against the sprinkler head, such as an inadvertent kick by the shoe of passersby or children playing, being struck by a stray basketball from the kids next door, being run over by lawnmower, car, golf cart, etc., or other such forces. It would therefore be desirable to provide a sprinkler structure that provides protection against such damaging forces.

Sometimes the sprinkler is not damaged by such forces, but its orientation or position in the ground shifts due to forces such as those described above, or by improper installation, or simply because of ground settling. For example, many new landscape installations use fresh top soil or have significant fill areas. Over a period of time, the top soil or fill areas may settle and cause a shift or tilt in the sprinkler positioning. This may result in a brown spot in a watered lawn because the sprinkler is prevented from providing its full spray pattern. For example, a sprinkler head with a 360 degree spray pattern may be tilted so that it sprays directly into the ground on one side while spraying up at some angle on the other side. Further, the user may try to compensate for the perceived lack of water in one zone by increasing the watering time at the controller for that zone, which does not solve the problem, wastes water and money, and may lead to erosion.

Another related problem is that when the sprinkler is moved, its setup and spray pattern may be inadvertently changed thereby rendering the sprinkler less effective. It would therefore be desirable to provide a sprinkler structure that also maintains the desired sprinkler positioning as set by the installer/user.

Finally, if a sprinkler is damaged, much effort is required to isolate and replace the broken sprinkler. It would therefore be desirable to provide a sprinkler structure that also allows access to the sprinkler for easy repair and replacement.

### SUMMARY

The present disclosure is directed to a structure useful for protecting and stabilizing lawn and garden sprinklers, and for providing easy access to repair a damaged sprinkler. In one embodiment, the structure includes a housing having a hollow cylindrical interior with open top and bottom. A resilient member is fixed within the hollow interior of the housing, and a central opening in the resilient member accommodates the body of the sprinkler. An adaptor may be used with the resilient member to accommodate different size sprinkler bodies.

When the sprinkler is in use, the head of the sprinkler extends through the top opening of the housing to deliver water spray. The resilient member tends to bias the sprinkler body to remain in an upright orientation, and any force asserted against the sprinkler head (for example, by an inadvertent kick) will be resisted by the resilient member. Small holes are provided through the resilient member to permit water drainage.

The structure preferably includes a cover that fits within the top opening of the housing over the top of the stabilizing member. In one embodiment, the cover includes a central opening that allows the sprinkler head to extend through the central opening in order to properly function, and additional openings to permit drainage of water through the cover. The openings are made small enough to prevent dirt, rocks, or other debris from falling into the housing. In another embodiment, the cover is made from a mesh material which permits drainage through the mesh.

The structure also preferably includes a notch in the side of the housing to receive a water pipe that is connected to the sprinkler.

The housing structure should be made from a durable material suitable for landscape applications, such as ABS plastic or equivalent materials. Structural features can be added to the structure in order to provide rigidity and stability to the housing structure.

A further understanding of the nature and advantages of the device disclosed herein may be realized by reference to the complete specification and the drawings herein.

### BRIEF DESCRIPTION OF THE DRAWINGS

FIG. 1 illustrates a perspective view of a housing for a lawn and garden sprinkler taken across section 1-1 of FIG. 3.

FIG. 2 illustrates a side plan view of the housing shown in FIG. 1 taken across section 1-1 of FIG. 3.

FIG. 3 illustrates a top plan view of the housing shown in FIG. 1.

FIG. 4 illustrates a perspective view of an alternative embodiment of a housing for a lawn and garden sprinkler.

FIG. 5 illustrates a perspective view of an alternative embodiment for a stabilizing member.

FIG. 6 illustrates a perspective view of an alternative embodiment of a housing having a notch to accommodate piping.

FIG. 7 illustrates a perspective view of an adaptor that fits within the stabilizing member of the housing of FIG. 1.

### DETAILED DESCRIPTION

This disclosure describes a structure for housing a lawn and garden sprinkler to provide protection, stabilization and easy access for repair, although application of the structure is not limited to sprinklers.

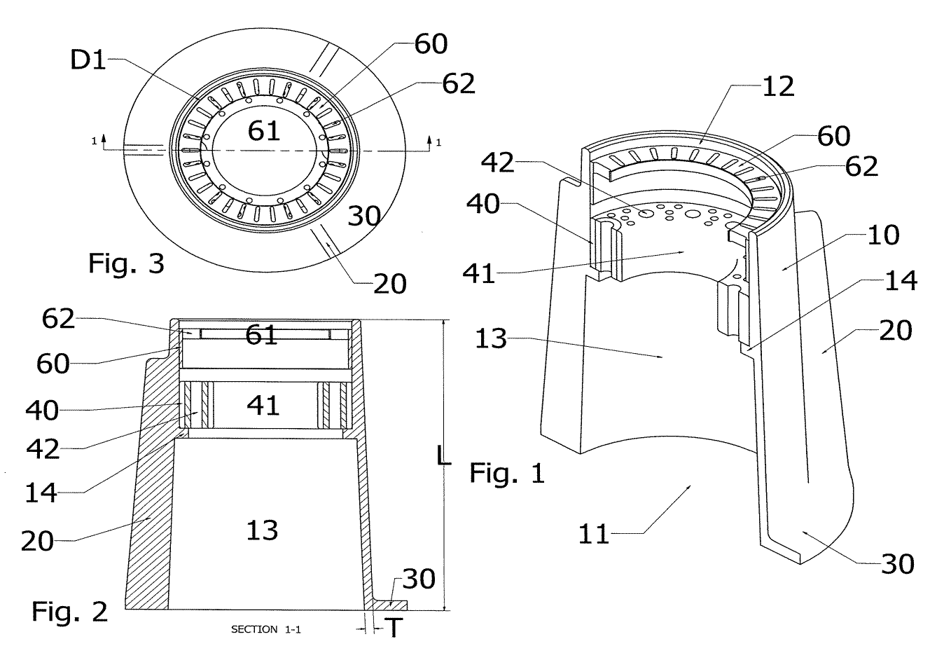

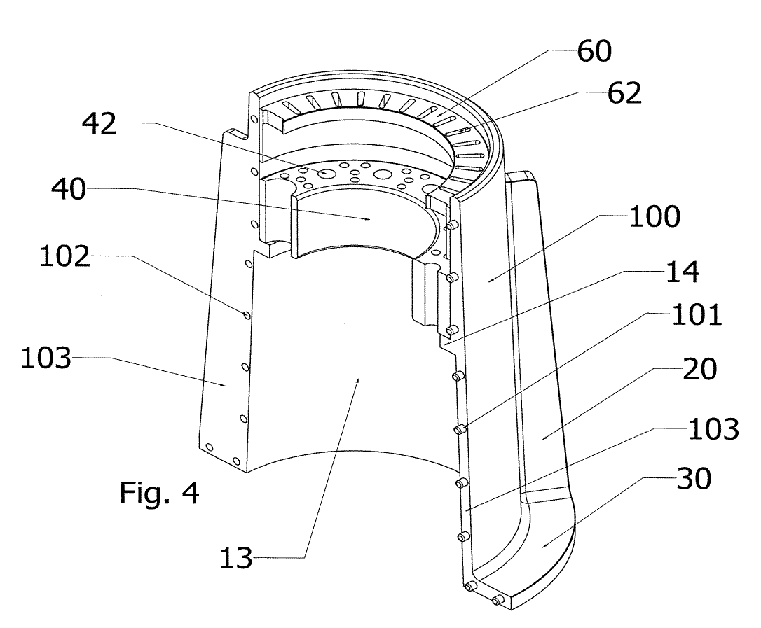

FIGS. 1-3 illustrate a housing 10, or cone, formed as a hollow structure having a bottom opening 11 and a top opening 12. The hollow interior space or chamber 13 inside the housing 10 is provided for containing the body of a lawn and garden sprinkler (not shown). The housing 10 may be formed from any durable material suitable for landscaping applications, such as molded ABS plastic or similar. The preferred shape of the housing 10 is a conical section, as shown, although it could take a different shape depending on the application and details of the sprinklers used. Further, in one embodiment shown in FIG. 4, a cone 100 could be formed as a two part housing (only one part shown) that snaps together around a sprinkler installation, for example, by providing interlocking tabs lo that insert into corresponding recesses 102 on the edges 103 of the cone portions. Other well known mechanical means could also be used to couple the two part housing together.

Preferably, the cone 10 should be formed with additional structural features in order to provide rigidity and stability to the cone, such as vertical fins 20 for resisting twisting forces and a horizontal flange 30 for resisting sinking or tilting forces. The number and type of features incorporated will depend upon the materials used and the specific application.

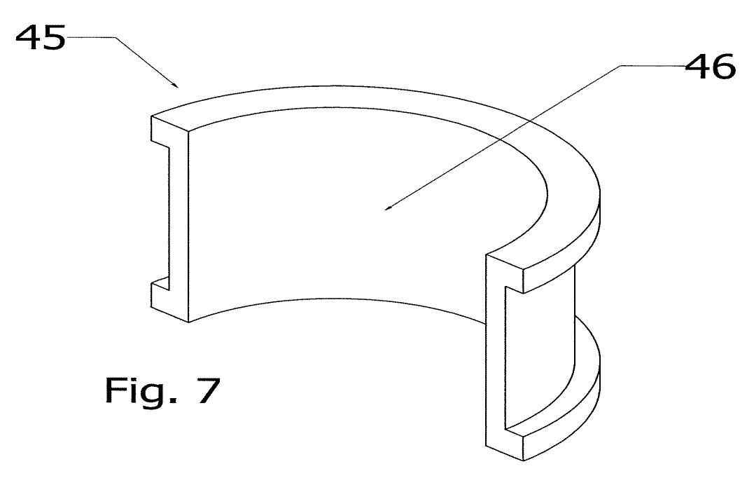

The cone 10 also includes an annular ridge 14 formed on the inside wall of the chamber 13 for holding a stabilizing member 40 in place within the cone. Other mechanical means could be used to secure the stabilizing member inside the cone, such as providing tabs on the stabilizing member that mate with corresponding grooves in the wall of the chamber in well known manner, or other suitable means. The stabilizing member is generally donut-shaped for this embodiment: round with a large hole or opening 41 in the middle for accommodating the body (not shown) of a lawn sprinkler. The size of the opening 41 may be varied to accommodate different size sprinklers. As a practical matter, the stabilizing member can be provided in several standard sizes so that the user can simply select the appropriate size. As an alternative, the stabilizing member 40 could be provided with one or more adaptors 45, as shown in FIG. 7, that fit within the opening 41 of the stabilizing member 40, in order to secure the donut against the body of a lawn and garden sprinkler with a smaller opening 46 in the adaptor.

The stabilizing member 40 or “donut” is preferably made of a resilient material, such as rubber or similar, in order to provide stability to the sprinkler as well as accommodate some degree of impact force (kicking, shovel, etc.) imparted against the sprinkler. Likewise, the adaptors 45 are preferably made from the same resilient material. However, other types of known resilient materials could be used, such as a spring, to provide stability and resiliency to piping or other internal element held in place by the resilient member.

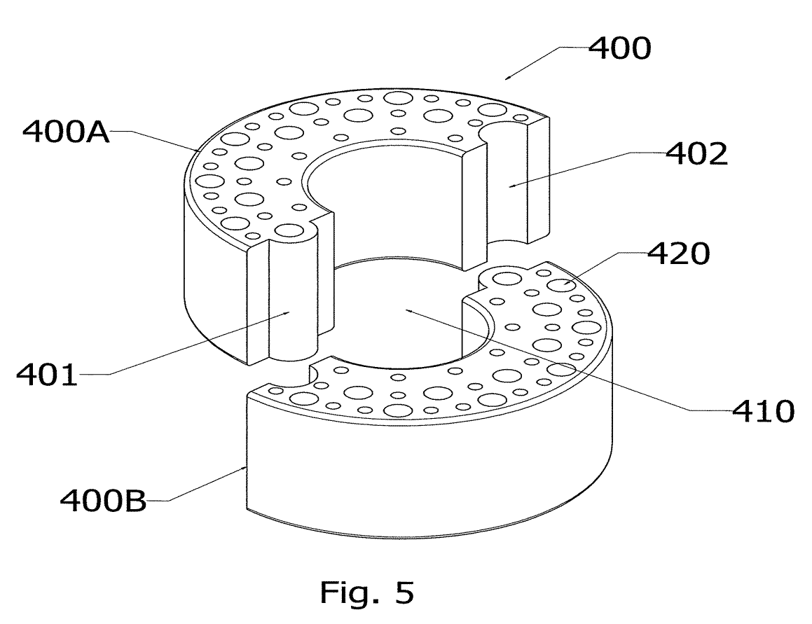

In addition to the large central opening 41, the donut 40 also includes drain openings 42 disposed around the periphery of the donut for allowing water to pass through the donut. An alternative design is shown in FIG. 5, wherein donut 400 is formed as two pieces 400A and 400B each having a tongue 401 and a groove 402 formed along the edges of the donut pieces, although any type or shape of mechanical interlock could be used. The donut pieces 400A and 400B are snapped together around the sprinkler body. Drain openings 420 are provided through each donut piece, and the central opening 410 is formed when the pieces are snapped together.

Returning to FIGS. 1-3, a cover 60 fits over the donut 40 within the top opening 12 of cone 10. The cover 60 may also be formed from molded ABS plastic like the cone, but could also be formed of other materials, for example, a preferred embodiment uses a plastic mesh material. In one embodiment, the cover 60 sits on top of the donut 40, although other means could be provided to hold the cover in place, such as an annular ring, tongue and groove interlocks, and other known mechanical methods. A central opening 61 is provided in the cover 60 for accommodating the sprinkler head extending above grade to deliver water spray. In the rigid ABS embodiment, a number of openings 62 are provided across the cover 60 to allow water drainage, although the use of mesh material avoids the need for drainage openings. The size of the openings 62 is relatively small so that dirt and other debris are prevented from going through the openings. Although openings 62 are shown as rectangular, they may be any suitable shape.

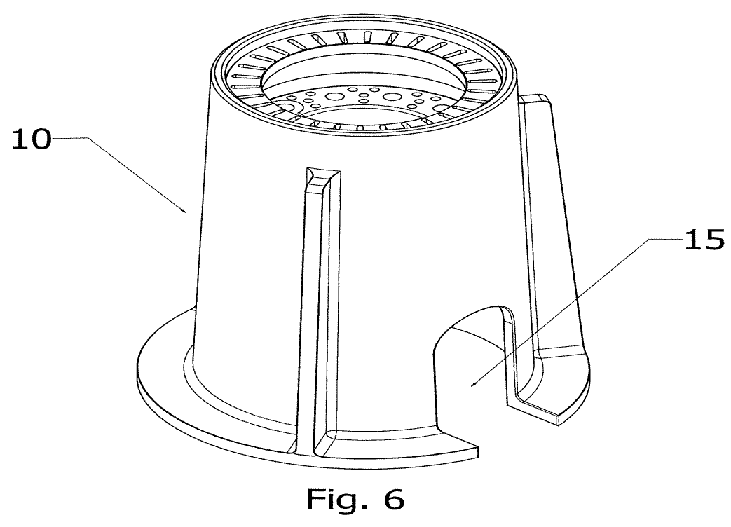

In another embodiment shown in FIG. 6, the housing 10 is formed with at least one notch 15 on the side of the housing near the bottom opening 11 in order to receive a water pipe into the housing. The notch may be sized to receive different sizes of pipe. Also, in another embodiment, a second corresponding notch may be formed in the other side of the housing to accommodate a water pipe that does not terminate at the sprinkler, but continues on to other sprinkler locations.

In one typical embodiment suitable for accommodating a common lawn sprinkler using ABS plastic, the cone 10 has an overall length L of approximately 7.32 inches, an inside diameter D1 of approximately 3.75 inches, and a typical thickness T of approximately 0.200 inches. The donut 40 and cover plate 60 have an outside diameter just less than approximately 3.75 inches to provide a snug fit inside the cone 10. The diameter of the central opening 41 of the donut 40 and the diameter of the central opening 61 of the cover plate 60 both depend on the size of the lawn sprinkler, and different sizes of each may be provided for convenience, or an adaptor 45 may be used to take up excess space for a snug fit.

In general, those skilled in the art to which this disclosure relates will recognize that many changes in construction and materials as well as widely differing embodiments will suggest themselves without departing from the spirit and essential characteristics of this disclosure. For example, although the preferred embodiment is described in the context of a lawn sprinkler application, other applications could benefit from having a housing structure with a resilient member to stabilize and protect internal elements, including other piping applications (such as gas, water, sewer, ventilation) and wiring applications (cable, wire, telephone). Accordingly, the disclosures and descriptions herein are intended to be illustrative only, and not limiting, of the scope of the invention, which is set forth in the claims.

1. A sprinkler housing, comprising:
a housing having a hollow interior space, a top opening communicating with the hollow space, and a bottom opening communicating with the hollow space; and
a resilient element having a central opening and held in place within the hollow space of the housing;
wherein a lawn sprinkler may be fitted within the hollow space of the housing such that a body of the sprinkler fits within the central opening of the resilient element and a head of the sprinkler extends through the top opening of the housing.

2. A sprinkler housing as in claim 1, further comprising a cover plate having a central opening and held in place within the top opening of the housing, wherein the head of the sprinkler extends through the central opening of the cover plate and the top opening of the housing.

3. A sprinkler housing as in claim 1, further comprising a ridge formed to extend from an interior wall of the housing, wherein the resilient element is held in place by the ridge.

4. A sprinkler housing as in claim 1, wherein the housing is a conical section, and further comprising an annular ridge formed to extend from an interior wall of the housing, wherein the resilient element is held in place by the annular ridge.

5. A sprinkler housing as in claim 1, wherein the resilient element and the housing have corresponding mechanical features that fix the resilient element in place within the housing.

6. A sprinkler housing as in claim 1, further comprising a notch formed on a side of the housing proximate to the bottom opening.

7. A sprinkler housing as in claim 1, further comprising an adaptor that fits within the central opening of the resilient element, the adaptor having a central opening that is smaller than the central opening of the resilient element.

8. A sprinkler housing, comprising:
a housing having a conical shape with a hollow interior space, a top opening communicating with the interior space, a bottom opening communicating with the interior space, and an annular ridge formed on an interior wall of the housing;
a resilient element having a central opening and held in place within the interior space of the housing by the annular ridge; and
a cover plate having a central opening and fitted within the top opening of the housing;
wherein a body portion of a lawn sprinkler fits within the central opening of the resilient element and a head portion of the lawn sprinkler extends through the central opening of the cover plate.

9. A sprinkler housing as in claim 8, wherein the resilient element and the cover plate include drainage openings.

10. A sprinkler housing as in claim 8, wherein the housing further includes at least one stabilizing structural feature.

11. A sprinkler housing as in claim 10, wherein the stabilizing structural feature resists twisting of the housing.

12. A sprinkler housing as in claim 10, wherein the stabilizing structural feature resists sinking of the housing.

13. A sprinkler housing as in claim 8, wherein the housing is formed in two parts that are fitted together.

14. A sprinkler housing as in claim 8, wherein the resilient element is formed in two parts that are fitted together.

15. A sprinkler housing as in claim 8, further comprising an adaptor fitted within the central opening of the resilient element, the adaptor having a central opening that is smaller than the central opening of the resilient element.

16. A sprinkler housing as in claim 8, further comprising a notch formed on a side of the housing proximate to the bottom opening.

17. A protective structure, comprising:
a housing having a hollow interior space and an opening communicating with the interior space; and
a resilient member fixed within the interior space of the housing;
wherein an internal element is held in place within the housing by the resilient member.

18. A protective structure as in claim 17, further a notch formed on a side of the housing.

19. A protective structure as in claim 17, wherein the resilient member has a central opening, and a body of the internal element is held in place within the central opening of the resilient member.

20. A protective structure as in claim 19, further comprising an adaptor fitted within the central opening of the resilient member, the adaptor having a central opening that is smaller than the central opening of the resilient member, and the body of the internal element is held in place within the central opening of the adaptor.
